(19) United States
(12) Patent Application Publication
(10) Pub. No.: US 2021/0141211 A1
(43) Pub. Date: May 13, 2021

(54) Eyepiece and Display Device

(71) Applicant: ZHEJIANG SUNNY OPTICS CO., LTD., Yuyao, Zhejiang (CN)

(72) Inventors: Qiqi LOU, Yuyao, Zhejiang (CN); Litong SONG, Yuyao, Zhejiang (CN)

(21) Appl. No.: 16/962,856

(22) PCT Filed: Apr. 25, 2019
(86) PCT No.: PCT/CN2019/084346

§ 371 Date: Jul. 17, 2020

(30) Foreign Application Priority Data
Aug. 2, 2018 (CN) 201810873331.4

(51) Int. Cl. G02B 25/00; G02B 9/04; G02B 27/00

(52) U.S. Cl. CPC G02B 25/001; G02B 27/0025; G02B 9/04

(57) ABSTRACT

An eyepiece and a display device are provided. The eyepiece includes: a lens component, the lens component including at least two lenses which are a first lens and a second lens; a reflective linear polarizer, arranged on a surface of the first lens or arranged on a surface of the second lens; a reflective circular polarizer, arranged on a surface of the first lens, the reflective circular polarizer being arranged on a side, far away from the image source, of the reflective linear polarizer; and a ¼λ wave plate, arranged between the reflective linear polarizer and the reflective circular polarizer, the first lens having a positive refractive power or a negative refractive power, the second lens having a negative refractive power, an Abbe number Vd1 of material of the first lens being greater than and an Abbe number Vd2 of material of the second lens being less than 30.

### CROSS-REFERENCE TO RELATED APPLICATIONS

The present disclosure claims priority to Chinese Patent Application No. 2018108733314, submitted to the China National Intellectual Property Administration (CHIPA) on Aug. 2, 2018, the contents of which are hereby incorporated by reference in its entirety.

### TECHNICAL FIELD

The disclosure relates to the field of optics, and particularly to an eyepiece and a display device.

### BACKGROUND

In recent years, along with the rapid development of computer technologies, Virtual Reality (VR) has become increasingly mature and perfect and has been applied more and more to the professional and consumption fields, A VR eyepiece, as a core optical element of a head-mounted display device, directly influences application and experience effects of the device, so high requirements are made to imaging quality and appearance quality of the eyepiece.

For providing a good user experience, a wearable VR device is required to achieve a relatively good field of view and eye movement range, a high-quality imaging effect, a small-sized ultra-thin structure and the like. In order to achieve the purpose, a lens group of an optical amplification module structure is required to be optimally designed.

For achieving a relatively high amplification factor, a VR imaging eyepiece is usually required to have a relatively long working distance as well as a relatively great chromatic aberration and distortion. However, such a design may not meet requirements of a user on a light and thin structure and high performance of a head-mounted device.

### SUMMARY

According to an aspect of the disclosure, an eyepiece is provided, which includes: a lens component with a positive refractive power or a negative refractive power, the lens component including at least two lenses which are a first lens and a second lens respectively along a direction close to an image source; a reflective linear polarizer, arranged on a surface, close to the image source, of the first lens or arranged on a surface of the second lens; a reflective circular polarizer, arranged on a surface of the first lens, the reflective circular polarizer being arranged on a side, far away from the image source, of the reflective linear polarizer; and a ¼λ wave plate, arranged between the reflective linear polarizer and the reflective circular polarizer, the first lens having a positive refractive power or a negative refractive power, the second lens having a negative refractive power, an Abbe number Vd1 of material of the first lens satisfying the following relationship: Vd1>5 and an Abbe number Vd2 of material of the second lens satisfying the following relationship: Vd2<30.

Optionally, a maximum lateral chromatic aberration of the eyepiece is LACL, LACL<60 μm.

Optionally, the surface, close to the image source, of the first lens is a second surface, and the second surface of the first lens is a convex surface.

Optionally, a radius of curvature of the second surface of the first lens is R2, and an effective focal length of the eyepiece is f, −3<R2/f<0.

Optionally, a distance on an optical axis between a center of an object-side surface of the first lens and a surface of the image source is a Total Track Length (TTL), and a half of a diagonal length of an effective pixel region of the surface of the image source is ImgH, TTL/ImgH<1.3.

Optionally, a maximum field of view of the eyepiece is a Horizontal Field Of View (HFOV), tan(HFOV)>1.

Optionally, the lens component further includes a third lens, and the third lens is arranged on a side, far away from the first lens, of the second lens.

According to another aspect of the disclosure, an eyepiece is provided, which includes: a lens component with a positive refractive power or a negative refractive power, the lens component including at least two lenses which are a first lens and a second lens respectively along a direction close to an image source; a reflective linear polarizer, arranged on a surface, close to the image source, of the first lens or arranged on a surface of the second lens; a reflective circular polarizer, arranged on any surface of the first lens, the reflective circular polarizer being arranged on a side, far away from the image source, of the reflective linear polarizer; and a ¼λ wave plate, arranged between the reflective linear polarizer and the reflective circular polarizer.

Optionally, the first lens has a positive refractive power or a negative refractive power, and the second lens has a negative refractive power.

Optionally, an Abbe number Vd1 of material of the first lens satisfies the following relationship: Vd1>50, and an Abbe number Vd2 of material of the second lens satisfies the following relationship: Vd2<30.

Optionally, a maximum lateral chromatic aberration of the eyepiece is LACL, LACL<60 μm.

Optionally, the surface, close to the image source, of the first lens is a second surface, and the second surface of the first lens is a convex surface.

Optionally, a radius of curvature of the second surface of the first lens is R2, and an effective focal length of the eyepiece is f, −3<R2/f<0.

Optionally, a distance on an optical axis between a center of an object-side surface of the first lens and a surface of the image source is TTL, and a half of a diagonal length of an effective pixel region of the surface of the image source is ImgH, TTL/ImgH<1.3.

Optionally, a maximum field of view of the eyepiece is HFOV, tan(HFOV)>1.

Optionally, the lens component further includes a third lens, and the third lens is arranged on a side, far away from the first lens, of the second lens.

According to another aspect of the disclosure, a display device is provided, which includes an eyepiece, the eyepiece being any abovementioned eyepiece.

Optionally, the display device is a head-mounted VR display device.

### BRIEF DESCRIPTION OF THE DRAWINGS

The drawings forming part of the disclosure in the specification are adopted to provide a further understanding to the disclosure. Schematic embodiments of the disclosure and descriptions thereof are adopted to explain the disclosure and not intended to form improper limits to the disclosure. In the drawings:

FIG. 1 is a structure diagram of an eyepiece according to embodiment 1;

FIG. 2 is a lateral color curve of an eyepiece according to embodiment 1;

FIG. 3 is a structure diagram of an eyepiece according to embodiment 2;

FIG. 4 is a lateral color curve of an eyepiece according to embodiment 2;

FIG. 5 is a structure diagram of an eyepiece according to embodiment 3;

FIG. 6 is a lateral color curve of an eyepiece according to embodiment 3;

FIG. 7 is a structure diagram of an eyepiece according to embodiment 4;

FIG. 8 is a lateral color curve of an eyepiece according to embodiment 4;

FIG. 9 is a structure diagram of an eyepiece according to embodiment 5;

FIG. 10 is a lateral color curve of an eyepiece according to embodiment 5;

FIG. 11 is a structure diagram of an eyepiece according to embodiment 6; and

FIG. 12 is a lateral color curve of an eyepiece according to embodiment 6.

Herein, the drawings include the following reference signs:

10: first lens; 20: second lens; 30: third lens; 01: human eye.

### DETAILED DESCRIPTION OF THE EMBODIMENTS

It is to be pointed out that the following detailed descriptions are exemplary and made to further describe the disclosure. Unless otherwise specified, all technical and scientific terms used herein have the same meanings usually understood by those of ordinary skill in the art of the disclosure.

It is to be noted that terms used herein are only adopted to describe specific implementation modes and not intended to limit exemplary implementation modes according to the disclosure. For example, singular forms, used herein, are also intended to include plural forms, unless otherwise clearly pointed out. In addition, it is also to be understood that terms “contain” and/or “include” used in the specification refer/refers to existence of features, steps, operations, apparatuses, components and/or combinations thereof.

It is to be understood that, when a component (for example, a layer, a film, a region or a substrate) is described to be “on” another component, the component may be directly on the other component or there may be an intermediate component.

Unless otherwise defined, all terms (including technical terms and scientific terms) used herein have the same meanings usually understood by those of ordinary skill in the art of the disclosure. It is also to be understood that the terms (for example, terms defined in a common dictionary) should be explained to have meanings consistent with the meanings in the context of a related art and may not be explained with ideal or excessively formal meanings, unless clearly defined like this in the disclosure.

It is to be noted that the embodiments in the disclosure and characteristics in the embodiments may be combined without conflicts.

As introduced in the Background, a working distance of a VR eyepiece in the conventional art is relatively long. For solving the technical problem, the disclosure discloses an eyepiece and a display device.

In some embodiments of the disclosure, an eyepiece is provided. As shown in FIG. 1, FIG. 3, FIG. 5, FIG. 7, FIG. 9 and FIG. 11, the eyepiece includes a lens component, a reflective linear polarizer, a reflective circular polarizer and a ¼λ wave plate. The lens component includes at least two lenses which are a first lens 10 and a second lens 20 respectively, and the first lens 10 and the second lens 20 are sequentially arranged along a direction close to an image source. The reflective linear polarizer is arranged on a surface, close to the image source, of the first lens 10 or arranged on a surface of the second lens 20. The reflective circular polarizer is arranged on a surface of the first lens 10, and the reflective circular polarizer is arranged on a side, far away from the image source, of the reflective linear polarizer. The ¼λ wave plate is arranged between the reflective linear polarizer and the reflective circular polarizer. The first lens 10 has a positive refractive power or a negative refractive power, the second lens 20 has a negative refractive power, an Abbe number Vd1 of material of the first lens 10 satisfies the following relationship: Vd1>5, and an Abbe number Vd2 of material of the second lens 20 satisfies the following relationship: Vd2<30.

For convenient description, it is defined that a surface, close to a human eye (namely far away from the image source), of the first lens is a first surface of the first lens and a surface close to the image source (namely far away from the human eye) is a second surface of the first lens and it is defined that a surface, close to the human eye (namely far away from the image source), of the second lens is a first surface of the second lens and a surface close to the image source (namely far away from the human eye) is a second surface of the second lens.

There are multiple arrangement manners of structures in the eyepiece of the present disclosure. For example, in embodiment 1 shown in FIG. 1, although the reflective circular polarizer and the reflective linear polarizer are not shown in the figure, it can be seen according to a light path diagram that the reflective circular polarizer is arranged on the first surface of the first lens 10 and the reflective linear polarizer is arranged on the second surface of the first lens 10.

For example, in embodiment 2 shown in FIG. 3, it can be seen according to a light path diagram that the reflective circular polarizer is arranged on the first surface of the first lens 10 and the reflective linear polarizer is arranged on the second surface of the second lens 20.

For example, in embodiment 3 shown in FIG. 5, the reflective circular polarizer is arranged on the first surface of the first lens 10 and the reflective linear polarizer is arranged on the first surface of the second lens 20.

For example, in embodiment 4 shown in FIG. 7, the reflective circular polarizer is arranged on the second surface of the first lens 10 and the reflective linear polarizer is arranged on the second surface of the second lens 20.

For example, in embodiment 5 shown in FIG. 9, the reflective circular polarizer is arranged on the first surface of the first lens 10 and the reflective linear polarizer is arranged on the first surface of the second lens 20.

For example, in embodiment 6 shown in FIG. 11, the reflective circular polarizer is arranged on the first surface of the first lens 10 and the reflective linear polarizer is arranged on the first surface of the second lens 20.

Of course, the arrangement manner of structures in the eyepiece of the disclosure is not limited to the manners in the abovementioned six embodiments, and another arrangement manner may be adopted. For example, the reflective circular polarizer is arranged on the second surface of the first lens, and the reflective linear polarizer is also arranged on a surface, far away from the first lens, of the reflective circular polarizer, namely the reflective linear polarizer is practically also arranged on the second surface of the first lens. Those skilled in the art can select a proper arrangement manner according to a practical condition to form the eyepiece of the disclosure if the abovementioned arrangement requirement is met.

A working process of the eyepiece in the disclosure is described with the eyepiece of embodiment 2 as an example. Light emitted from an image source side sequentially passes through the reflective linear polarizer, the second lens 20, the ¼λ wave plate and the first lens 10, reaches the reflective circular polarizer, is reflected to pass through the first lens 10, the ¼λ wave plate and the second lens 20 and then is reflected by the reflective linear polarizer, thereby sequentially passing through the second lens 20, the ¼λ wave plate, the first lens 10 and the reflective circular polarizer again to enter the human eye.

According to the eyepiece, the light, before entering the human eye, is reflected twice, so that a physical distance between the human eye and the image source in a direction of the optical axis is reduced, and the eyepiece is light and thin. Moreover, in the eyepiece of the disclosure, the first lens has a positive refractive power or a negative refractive power, the second lens has a negative refractive power, the Abbe number Vd1 of the material of the first lens is greater than 5, and the Abbe number Vd2 of the material of the second lens is less than 30, so that the size of the lens is reduced to further achieve a light and thin structure of the eyepiece, and meanwhile, an imaging chromatic aberration is also reduced to further improve the imaging quality of the eyepiece.

In some embodiments of the disclosure, a maximum lateral chromatic aberration of the eyepiece is LACL, LACL<60 μm. In the embodiment, the LACL is relatively low, so that the imaging quality of the eyepiece is effectively improved, an image seen by the human eye further has a relatively low chromatic aberration and is relatively uniform in color, and the visual comfort of the human eye is improved.

For effectively reducing a field curvature and spherical aberration of the eyepiece and achieving relatively high imaging performance, in some embodiments of the disclosure, as shown in FIG. 1, FIG. 3, FIG. 5, FIG. 7, FIG. 9 and FIG. 11, the surface, close to the image source, of the first lens 10 is a second surface, and the second surface of the first lens 10 is a convex surface.

In some other embodiments of the disclosure, a radius of curvature of the second surface of the first lens is R2, and an effective focal length of the eyepiece is f, −3<R2/f<0. Therefore, the field curvature and distortion of the eyepiece is further reduced effectively, meanwhile, the size of the eyepiece is further reduced, the imaging quality of the eyepiece is further improved, and a light and thin structure of the eyepiece is further achieved.

For further reducing the total length of the eyepiece and meeting a requirement on the light and thin structure, in some embodiments of the disclosure, a distance on an optical axis between a center of an object-side surface of the first lens and a surface of the image source is TTL, and a half of a diagonal length of an effective pixel region of the surface of the image source is ImgH, TTL/ImgH<1.3.

In some other embodiments of the disclosure, a maximum field of view of the eyepiece is HFOV, tan(HFOV)>1. Therefore, relatively good immersion of the eyepiece is achieved.

For further ensuring improving of the imaging quality of the eyepiece, in some embodiments of the disclosure, for example, in embodiment 6 shown in FIG. 11, the lens component further includes a third lens 30, and the third lens 30 is arranged on a side, far away from the first lens 10, of the second lens 20.

Of course, the number of lenses in the disclosure is not limited to two or three and may be larger. Those skilled in the art may selectively arrange a proper number of lenses according to the practical condition. Elaborations are omitted herein.

In some other embodiments of the disclosure, an eyepiece is provided. As shown in FIG. 1, FIG. 3, FIG. 5, FIG. 7, FIG. 9 and FIG. 11, the eyepiece includes a lens component, a reflective linear polarizer, a reflective circular polarizer and a ¼λ wave plate. The lens component includes at least two lenses which are a first lens 10 and a second lens 20 respectively, and the first lens 10 and the second lens 20 are sequentially arranged along a direction close to an image source. The reflective linear polarizer is arranged on a surface, close to the image source, of the first lens 10 or arranged on a surface of the second lens 20. The reflective circular polarizer is arranged on a surface of the first lens 10, and the reflective circular polarizer is arranged on a side, far away from the image source, of the reflective linear polarizer. The ¼λ wave plate is arranged between the reflective linear polarizer and the reflective circular polarizer.

Similarly, there are multiple arrangement manners of structures in the eyepiece of the present disclosure. In embodiment 1 shown in FIG. 1, although the reflective circular polarizer and the reflective linear polarizer are not shown in the figure, it can be seen according to a light path diagram that the reflective circular polarizer is arranged on a first surface of the first lens 10 and the reflective linear polarizer is arranged on a second surface of the first lens 10. In embodiment 2 shown in FIG. 3, it can be seen according to a light path diagram that the reflective circular polarizer is arranged on the first surface of the first lens 10 and the reflective linear polarizer is arranged on a second surface of the second lens 20. In embodiment 3 shown in FIG. 5, the reflective circular polarizer is arranged on the first surface of the first lens 10 and the reflective linear polarizer is arranged on a first surface of the second lens 20. In embodiment 4 shown in FIG. 7, the reflective circular polarizer is arranged on the second surface of the first lens 10 and the reflective linear polarizer is arranged on the second surface of the second lens 20. In embodiment 5 shown in FIG. 9, the reflective circular polarizer is arranged on the first surface of the first lens 10 and the reflective linear polarizer is arranged on the first surface of the second lens 20. In embodiment 6 shown in FIG. 11, the reflective circular polarizer is arranged on the first surface of the first lens 10 and the reflective linear polarizer is arranged on the first surface of the second lens 20.

Of course, the arrangement manner of structures in the eyepiece of the disclosure is not limited to the manners in the abovementioned six embodiments, and another arrangement manner may be adopted. For example, the reflective circular polarizer is arranged on the second surface of the first lens, and the reflective linear polarizer is also arranged on a surface, far away from the first lens, of the reflective circular polarizer, namely the reflective linear polarizer is practically also arranged on the second surface of the first lens. Those skilled in the art can select a proper arrangement manner according to a practical condition to form the eyepiece of the disclosure if the abovementioned arrangement requirement is met.

Similarly, a working process of the eyepiece is described with the eyepiece of embodiment 2 as an example. Light emitted from an image source side sequentially passes through the reflective linear polarizer, the second lens 20, the ¼λ wave plate and the first lens 10, reaches the reflective circular polarizer, is reflected to pass through the first lens 10, the ¼λ wave plate and the second lens 20 and then is reflected by the reflective linear polarizer, thereby sequentially passing through the second lens 20, the ¼λ wave plate, the first lens 10 and the reflective circular polarizer again to enter the human eye.

According to the eyepiece, the light, before entering the human eye, is reflected twice, so that a physical distance between the human eye and the image source in a direction of the optical axis is reduced, and the eyepiece is light and thin.

For reducing the size of the lens, further achieving a light and thin structure of the eyepiece, simultaneously reducing an imaging chromatic aberration of the eyepiece and improving the imaging quality of the eyepiece, in some embodiments of the disclosure, the first lens has a positive refractive power or a negative refractive power, and the second lens has a negative refractive power.

For further reducing the size of the lens and simultaneously further reducing the imaging chromatic aberration of the eyepiece, in some embodiments of the disclosure, an Abbe number Vd1 of material of the first lens satisfies the following relationship: Vd1>50, and an Abbe number Vd2 of material of the second lens satisfies the following relationship: Vd2<30.

In some embodiments of the disclosure, a maximum lateral chromatic aberration of the eyepiece is LACL, LACL<60 μm. In the embodiment, the LACL is relatively low, so that the imaging quality of the eyepiece is effectively improved, and the visual comfort of the human eye is improved.

For effectively reducing a field curvature and spherical aberration of the eyepiece and achieving relatively high imaging performance, in some embodiments of the disclosure, as shown in FIG. 1, FIG. 3, FIG. 5, FIG. 7, FIG. 9 and FIG. 11, the surface, close to the image source, of the first lens 10 is a second surface, and the second surface of the first lens 10 is a convex surface.

In some other embodiments of the disclosure, a radius of curvature of the second surface of the first lens is R2, and an effective focal length of the eyepiece is f, −3<R2/f<0. Therefore, the field curvature and distortion of the eyepiece is further reduced effectively, meanwhile, the size of the eyepiece is further reduced, the imaging quality of the eyepiece is further improved, and a light and thin structure of the eyepiece is further achieved.

For further reducing the total length of the eyepiece and meeting a requirement on the light and thin structure, in some embodiments of the disclosure, a distance on an optical axis between a center of an object-side surface of the first lens and a surface of the image source is TTL, and a half of a diagonal length of an effective pixel region of the surface of the image source is ImgH, TTL/ImgH<1.3.

In some other embodiments of the disclosure, a maximum field of view of the eyepiece is HFOV, tan(HFOV)>1. Therefore, relatively good immersion of the eyepiece is achieved.

For further ensuring the imaging quality of the eyepiece, in some embodiments of the disclosure, for example, in embodiment 6 shown in FIG. 11, the lens component further includes a third lens 30, and the third lens 30 is arranged on the side, far away from the first lens 10, of the second lens 20.

In some other embodiments the disclosure, a display device is provided, which includes an eyepiece, the eyepiece is any abovementioned eyepiece.

The display device includes the eyepiece, so that the display device meets a requirement on a light and thin structure, and a displayed image is relatively high in quality.

In some specific embodiments, the display device is a head-mounted VR display device.

For enabling those skilled in the art to understand the technical solutions and technical effects of the disclosure more clearly, descriptions will be made below in combination with specific embodiments.

### Embodiment 1

Along a direction close to an image source, an eyepiece includes a reflective circular polarizer, a first lens 10, a ¼λ wave plate, a reflective linear polarizer and a second lens 20 that are sequentially arranged, specifically referring to FIG. 1. The reflective linear polarizer, the reflective circular polarizer and the ¼λ wave plate are not shown in the figure.

A light path of the embodiment may refer to FIG. 1. From the side 01 of a human eye, light sequentially passes through S1 and is reflected twice until reaching an imaging surface S7. Parameters of each optical surface are shown in Table 1. S1 represents a first surface of the first lens 10, S2 represents a reflecting surface of the reflective linear polarizer, S3 represents a reflecting surface of the reflective circular polarizer, S4 represents a second surface of the first lens 10, S5 represents a first surface of the second lens 20, S6 represents a second surface of the second lens 20, and S7 represents a surface of the image source.

TABLE 1

| | | | | Material or | |
|---|---|---|---|---|---|
| | | | | refractive | |
| | | Radius of | | index/Abbe | |
| Surface | Surface | curvature | Thickness | number of | Conic |
| number | type | (mm) | (mm) | the material | coefficient |
| OBJ | Spherical | Infinite | −2000.0000 | — | — |
| EYE | Spherical | Infinite | 17.0000 | — | — |
| S1 | Spherical | −21.6683 | 6.5002 | 1.49/57.4 | 0.0151 |
| S2 | Spherical | −24.6120 | −6.5002 | MIRROR | 0.0165 |
| S3 | Spherical | −21.6683 | 6.5002 | MIRROR | 0.0151 |
| S4 | Spherical | −24.6120 | 0.9998 | — | 0.0165 |
| S5 | Spherical | −24.6120 | 4.8810 | 1.65/23.5 | 0.0165 |
| S6 | Spherical | −34.2065 | 12.5234 | — | 0.3219 |
| S7 | Spherical | Infinite | — | — | — |

In the embodiment, a focal length of the eyepiece is f, and f=32.41 mm, a focal length of the first lens 10 is f1, and f1=9.04 mm, a focal length of the second lens 20 is f2, and f2=−169.53, a maximum field of view of the eyepiece is HFOV, and HFOV=50°, a half of a diagonal length of an effective pixel region of the surface of the image source is ImgH, and ImgH=32.00 mm, and a maximum lateral chromatic aberration of the eyepiece is LACL, and LACL=19.51 μm, specifically as shown in Table 7.

In the embodiment, R2/f=−0.76, TTL/ImgH=0.78 and tan(HFOV)=1.19 is calculated according to the data, specifically as shown in Table 8.

It can be seen from the data that a working distance of the eyepiece of the embodiment is relatively short and requirements on miniaturization and a light and thin structure are met. A lateral color curve of the eyepiece of the embodiment is shown in FIG. 2. It can be seen from the figure that the eyepiece has a relatively low lateral color and relatively high imaging quality.

### Embodiment 2

Along a direction close to an image source, an eyepiece includes a reflective circular polarizer, a first lens 10, a ¼λ wave plate, a second lens 20 and a reflective linear polarizer that are sequentially arranged, specifically referring to FIG. 3. The reflective linear polarizer, the reflective circular polarizer and the ¼λ wave plate are not shown in the figure.

A light path of the embodiment may refer to FIG. 3. From the side 01 of a human eye, light sequentially passes through S1 and is reflected twice until reaching an imaging surface S11. Parameters of each optical surface are shown in Table 2. S1 represents a first surface of the first lens 10, S2 represents a second surface of the first lens S10, S3 represents a first surface of the second lens 20, S4 represents a reflecting surface of the reflective linear polarizer, S5 represents a first surface of the second lens 20, S6 represents the second surface of the first lens 10, S7 represents a reflecting surface of the reflective circular polarizer, S8 represents the second surface of the first lens 10, S9 represents the first surface of the second lens 20, S10 represents the second surface of the second lens 20, and S11 represents a surface of the image source.

TABLE 2

| | | | | Material or | |
|---|---|---|---|---|---|
| | | | | refractive | |
| | | Radius of | | index/Abbe | |
| Surface | Surface | curvature | Thickness | number of | Conic |
| number | type | (mm) | (mm) | the material | coefficient |
| OBJ | Spherical | Infinite | −2000.0000 | — | — |
| EYE | Spherical | Infinite | 17.0000 | — | — |
| S1 | Spherical | −52.7202 | 4.0295 | 1.49/57.4 | 3.5673 |
| S2 | Spherical | −31.2004 | 5.0797 | — | −0.5631 |
| S3 | Spherical | −36.6301 | 3.9972 | 1.65/23.5 | 0.3435 |
| S4 | Spherical | −46.8501 | −3.9972 | MIRROR | 0.8804 |
| S5 | Spherical | −36.6301 | −5.0797 | — | 0.3435 |
| S6 | Spherical | −31.2004 | −4.0295 | 1.49/57.4 | −0.5631 |
| S7 | Spherical | −52.7202 | 4.0295 | MIRROR | 3.5673 |
| S8 | Spherical | −31.2004 | 5.0797 | — | 0.5631 |
| S9 | Spherical | −36.6301 | 3.9972 | 1.65/23.5 | 0.3435 |
| S10 | Spherical | −46.8501 | 4.5666 | — | 0.8804 |
| S11 | Spherical | Infinite | — | — | |

In the embodiment, a focal length of the eyepiece is f, and f=30.74 mm, a focal length of the first lens is f1, and f1=145.70 mm, a focal length of the second lens is f2, and f2=−306.72, a maximum field of view of the eyepiece is HFOV, and HFOV=50°, a half of a diagonal length of an effective pixel region of the surface of the image source is ImgH, and ImgH=32.00 mm, and a maximum lateral chromatic aberration of the eyepiece is LACL, and LACL=11.62 μm, specifically as shown in Table 7.

In the embodiment, R2/f=−1.02, TTL/ImgH=0.55 and tan(HFOV)=1.19 is calculated according to the data, specifically as shown in Table 8.

It can be seen from the data that a working distance of the eyepiece of the embodiment is relatively short and requirements on miniaturization and a light and thin structure are met. A lateral color curve of the eyepiece of the embodiment is shown in FIG. 4. It can be seen from the figure that the eyepiece has a relatively low lateral color and relatively high imaging quality.

### Embodiment 3

Along a direction close to an image source, an eyepiece includes a reflective circular polarizer, a first lens 10, a ¼λ wave plate, a reflective linear polarizer and a second lens 20 that are sequentially arranged, specifically referring to FIG. 5. The reflective linear polarizer, the reflective circular polarizer and the ¼λ wave plate are not shown in the figure.

A light path of the embodiment may refer to FIG. 5. From the side 01 of a human eye, light sequentially passes through S1 and is reflected twice until reaching an imaging surface S9. Parameters of each optical surface are shown in Table 3. S1 represents a first surface of the first lens 10, S2 represents a second surface of the first lens S10, S3 represents a reflecting surface of the reflective linear polarizer, S4 represents the second surface of the first lens 10, S5 represents a reflecting surface of the reflective circular polarizer, S6 represents the second surface of the first lens 10, S7 represents a first surface of the second lens 20, S8 represents a second surface of the second lens 20, and S9 represents a surface of the image source.

TABLE 3

| | | | | Material or | |
|---|---|---|---|---|---|
| | | | | refractive | |
| | | Radius of | | index/Abbe | |
| Surface | Surface | curvature | Thickness | number of | Conic |
| number | type | (mm) | (mm) | the material | coefficient |
| OBJ | Spherical | Infinite | −2000.0000 | — | — |
| EYE | Spherical | Infinite | 15.0000 | — | — |
| S1 | Spherical | −565.4884 | 6.2398 | 1.49/57.4 | −66.1758 |
| S2 | Spherical | −53.7693 | 1.1458 | — | −1.8608 |
| S3 | Spherical | −147.6055 | −1.1458 | MIRROR | 13.3806 |
| S4 | Spherical | −53.7693 | −6.2398 | 1.49/57.4 | −1.8608 |
| S5 | Spherical | −565.4884 | 6.2398 | MIRROR | −66.1758 |
| S6 | Spherical | −53.7693 | 1.1458 | — | −1.8608 |
| S7 | Spherical | −147.6055 | 3.9999 | 1.65/23.5 | 13.3806 |
| S8 | Spherical | 125.5695 | 22.4937 | — | 15.2741 |
| S9 | Spherical | Infinite | — | — | — |

In the embodiment, a focal length of the eyepiece is f, and f=37.37 mm, a focal length of the first lens is f1, and f1=119.79 mm, a focal length of the second lens is f2, and f2=−104.30, a maximum field of view of the eyepiece is HFOV, HFOV=50°, a half of a diagonal length of an effective pixel region of the surface of the image source is ImgH, ImgH=32.00 mm, and a maximum lateral chromatic aberration of the eyepiece is LACL, and LACL=55.73 μm, specifically as shown in Table 7.

In the embodiment, R2/f=−1.44, TTL/ImgH=1.06 and tan(HFOV)=1.19 is calculated according to the data, specifically as shown in Table 8.

It can be seen from the data that a working distance of the eyepiece of the embodiment is relatively short and requirements on miniaturization and a light and thin structure are met. A lateral color curve of the eyepiece of the embodiment is shown in FIG. 6. It can be seen from the figure that the eyepiece has a relatively low lateral color and relatively high imaging quality.

### Embodiment 4

Along a direction close to an image source, an eyepiece includes a first lens 10, a reflective circular polarizer, a ¼λ wave plate, a second lens 20 and a reflective linear polarizer that are sequentially arranged, specifically referring to FIG. 7. The reflective linear polarizer, the reflective circular polarizer and the ¼λ wave plate are not shown in the figure.

A light path of the embodiment may refer to FIG. 7. From the side 01 of a human eye, light sequentially passes through S1 and is reflected twice until reaching an imaging surface S9. Parameters of each optical surface are shown in Table 4. S1 represents a first surface of the first lens 10, S2 represents a second surface of the first lens S10, S3 represents a first surface of the second lens 20, S4 represents a reflecting surface of the reflective linear polarizer, S5 represents the first surface of the second lens 20, S6 represents a reflecting surface of the reflective circular polarizer, S7 represents the first surface of the second lens 20, S8 represents a second surface of the second lens 20, and S9 represents a surface of the image source.

TABLE 4

| | | | | Material or | |
|---|---|---|---|---|---|
| | | | | refractive | |
| | | Radius of | | index/Abbe | |
| Surface | Surface | curvature | Thickness | number of | Conic |
| number | type | (mm) | (mm) | the material | coefficient |
| OBJ | Spherical | Infinite | −2000.0000 | — | — |
| EYE | Spherical | Infinite | 17.0000 | — | — |
| S1 | Spherical | −25.1129 | 4.9785 | 1.49/57.4 | −0.6159 |
| S2 | Spherical | −31.9884 | 8.0360 | — | 0.1046 |
| S3 | Spherical | −31.7589 | 3.9916 | 1.65/23.5 | −0.0145 |
| S4 | Spherical | −35.4595 | −3.9916 | MIRROR | −0.0508 |
| S5 | Spherical | −31.7589 | −8.0360 | — | −0.0145 |
| S6 | Spherical | −31.9884 | 8.0360 | MIRROR | 0.1046 |
| S7 | Spherical | −31.7589 | 3.9916 | 1.65/23.5 | −0.0145 |
| S8 | Spherical | −35.4595 | 2.9961 | — | −0.0508 |
| S9 | Spherical | Infinite | — | — | — |

In the embodiment, a focal length of the eyepiece is f, and f=31.23 mm, a focal length of the first lens 10 is f1, and f1=−310.96 mm, a focal length of the second lens 20 is f2, and f2=−816.29, a maximum field of view of the eyepiece is HFOV, and HFOV=50°, a half of a diagonal length of an effective pixel region of the surface of the image source is ImgH, and ImgH=32.00 mm, and a maximum lateral chromatic aberration of the eyepiece is LACL, and LACL=5.89 μm, specifically as shown in Table 7.

In the embodiment, R2/f=−1.02, TTL/ImgH=0.98 and tan(HFOV)=1.19 is calculated according to the data, specifically as shown in Table 8.

It can be seen from the data that a working distance of the eyepiece of the embodiment is relatively short and requirements on miniaturization and a light and thin structure are met. A lateral color curve of the eyepiece of the embodiment is shown in FIG. 8. It can be seen from the figure that the eyepiece has a relatively low lateral color and relatively high imaging quality.

### Embodiment 5

Along a direction close to an image source, an eyepiece includes a reflective circular polarizer, a first lens 10, a ¼λ wave plate, a reflective linear polarizer and a second lens 20 that are sequentially arranged, specifically referring to FIG. 9. The reflective linear polarizer, the reflective circular polarizer and the ¼λ wave plate are not shown in the figure.

A light path of the embodiment may refer to FIG. 9. From the side 01 of a human eye, light sequentially passes through S1 and is reflected twice until reaching an imaging surface S9. Parameters of each optical surface are shown in Table 3. S1 represents a first surface of the first lens 10, S2 represents a second surface of the first lens S10, S3 represents a reflecting surface of the reflective linear polarizer, S4 represents the second surface of the first lens 10, S5 represents a reflecting surface of the reflective circular polarizer, S6 represents the second surface of the first lens 10, S7 represents a first surface of the second lens 20, S8 represents a second surface of the second lens 20, and S9 represents a surface of the image source.

TABLE 5

| | | | | Material or | |
|---|---|---|---|---|---|
| | | | | refractive | |
| | | Radius of | | index/Abbe | |
| Surface | Surface | curvature | Thickness | number of | Conic |
| number | type | (mm) | (mm) | the material | coefficient |
| OBJ | Spherical | Infinite | −2000.0000 | — | — |
| EYE | Spherical | Infinite | 12.0000 | — | — |
| S1 | Spherical | 171.4327 | 6.6807 | 1.49/57.4 | −45.6266 |
| S2 | Spherical | −82.2832 | 0.9843 | — | 1.7290 |
| S3 | Spherical | Infinite | −0.9843 | MIRROR | — |
| S4 | Spherical | −82.2832 | −6.6807 | 1.49/57.4 | 1.7290 |
| S5 | Spherical | 171.4327 | 6.6807 | MIRROR | −45.6266 |
| S6 | Spherical | −82.2832 | 0.9843 | — | 1.7290 |
| S7 | Spherical | Infinite | 3.9382 | 1.65/23.5 | — |
| S8 | Spherical | 54.4706 | 23.1672 | — | 2.5243 |
| S9 | Spherical | Infinite | — | — | — |

In the embodiment, a focal length of the eyepiece is f, and f=36.65 mm, a focal length of the first lens is 11, and f1=113.53 mm, a focal length of the second lens is f2, and f2=−84.21, a maximum field of view of the eyepiece is HFOV, and HFOV=50°, a half of a diagonal length of an effective pixel region of the surface of the image source is ImgH, and ImgH,=32.00 mm, and a maximum lateral chromatic aberration of the eyepiece is LACL, and LACL=22.15 μm, specifically as shown in Table 7.

In the embodiment, R2/f=−2.25, TTL/ImgH=1.09 and tan(HFOV)=1.19 is calculated according to the data, specifically as shown in Table 8.

It can be seen from the data that a working distance of the eyepiece of the embodiment is relatively short and requirements on miniaturization and a light and thin structure are met. A lateral color curve of the eyepiece of the embodiment is shown in FIG. 10. It can be seen from the figure that the eyepiece has a relatively low lateral color and relatively high imaging quality.

### Embodiment 6

Along a direction close to an image source, an eyepiece includes a reflective circular polarizer, a first lens 10, a ¼λ wave plate, a reflective linear polarizer, a second lens 30 and a third lens 30 that are sequentially arranged, specifically referring to FIG. 11. The reflective linear polarizer, the reflective circular polarizer and the ¼λ wave plate are not shown in the figure.

A light path of the embodiment may refer to FIG. 11. From the side 01 of a human eye, light sequentially passes through S1 and is reflected twice until reaching an imaging surface S11. Parameters of each optical surface are shown in Table 3. S1 represents a first surface of the first lens 10, S2 represents a second surface of the first lens S10, S3 represents a reflecting surface of the reflective linear polarizer, S4 represents the second surface of the first lens 10, S5 represents a reflecting surface of the reflective circular polarizer, S6 represents the second surface of the first lens 10, S7 represents a first surface of the second lens 20, S8 represents a second surface of the second lens 20, S9 represents a first surface of the third lens 30, S10 represents a second surface of the third lens 30, and S11 represents a surface of the image source.

TABLE 6

| | | | | Material or | |
|---|---|---|---|---|---|
| | | | | refractive | |
| | | Radius of | | index/Abbe | |
| Surface | Surface | curvature | Thickness | number of | Conic |
| number | type | (mm) | (mm) | the material | coefficient |
| OBJ | Spherical | Infinite | −2000.0000 | — | — |
| EYE | Spherical | Infinite | 15.0000 | — | — |
| S1 | Spherical | −224.4233 | 4.9999 | 1.49/57.4 | 41.3680 |
| S2 | Spherical | −54.7922 | 0.9999 | — | 0.4504 |
| S3 | Spherical | −103.8230 | −0.9999 | MIRROR | 7.3405 |
| S4 | Spherical | −54.7922 | −4.9999 | 1.49/57.4 | 0.4504 |
| S5 | Spherical | −224.4233 | 4.9999 | MIRROR | 41.3680 |
| S6 | Spherical | −54.7922 | 0.9999 | — | 0.4504 |
| S7 | Spherical | −103.8230 | 3.9997 | 1.65/23.5 | 7.3405 |
| S8 | Spherical | 111.8663 | 1.0000 | — | 1.7652 |
| S9 | Spherical | 69.4345 | 6.4895 | 1.49/57.4 | −11.0733 |
| S10 | Spherical | −494.6155 | 19.4724 | — | −98.5919 |
| S11 | Spherical | Infinite | — | — | — |

In the embodiment, a focal length of the eyepiece is f, and f=36.78 mm, a focal length of the first lens is f1, and f1=145.32 mm, a focal length of the second lens is f2, and f2=−82.65, a focal length of the third lens is f3, and f3=123.72, a maximum field of view of the eyepiece is HFOV, and HFOV=50°, a half of a diagonal length of an effective pixel region of the surface of the image source is ImgH, and ImgH=32.00 mm, and a maximum lateral chromatic aberration of the eyepiece is LACL, and LACL=30.86 μm, specifically as shown in Table 7.

In the embodiment, R2/f=−1.49, TTL/ImgH=1.15 and tan(HFOV)=1.19 is calculated according to the data, specifically as shown in Table 8.

It can be seen from the data that a working distance of the eyepiece of the embodiment is relatively short and requirements on miniaturization and a light and thin structure are met. A lateral color curve of the eyepiece of the embodiment is shown in FIG. 12. It can be seen from the figure that the eyepiece has a relatively low lateral color and relatively high imaging quality.

It is to be noted that, in specific design parameter tables corresponding to each embodiment, OBJ represents an object in an optical system, EYE represents the human eye, thickness represents a distance between an Si surface and an S(i+1) surface, and moreover, it is defined that a direction from the human eye to the image source is positive. The light is reflected to an opposite direction when encountering a surface which is MIRROR in material column, reflected again when reaching the second surface which is MIRROR in material column and then propagated from left to right and finally reaches the surface of the image source.

It is to be noted that Si of which i is the same in different embodiment may represent different optical surfaces and the specific optical surface is required to be determined according to the light path in each embodiment.

It is to be noted that, in the structure diagram of the eyepiece corresponding to each embodiment, although the reflective circular polarizer and the reflective linear polarizer are not shown, it can be seen according to the light path that the two polarizers are attached to the first lens or the second lens, and in each structure diagram, the surface, to which the polarizer is attached, of the lens also represents a surface of the corresponding polarizer and the surface of the lens.

It is to be noted that “material or refractive index/Abbe number of the material” in Table 1 to Table 6 represents the material or the refractive index/Abbe number of the material between the optical surface in the same row and the optical surface of the next row. For example, “-” in the same row as S5 in Table 2 represents that the material between S5 and S6 is air. For another example, since the material between S6 and S7 is the material of the first lens, “1.49/57.4” in the same row as S6 in Table 2 is a corresponding parameter of the material of the first lens.

TABLE 7

| | f | f1 | f2 | f3 | HFOV | ImgH | LACL |
|---|---|---|---|---|---|---|---|
| Parameter | (mm) | (mm) | (mm) | (mm) | (°) | (mm) | (μm) |
| Embodi- | 32.41 | 9.04 | −169.53 | NA | 50.0 | 32.00 | 19.51 |
| ment 1 | | | | | | | |
| Embodi- | 30.74 | 145.70 | −306.72 | NA | 50.0 | 32.00 | 11.62 |
| ment 2 | | | | | | | |
| Embodi- | 37.37 | 119.79 | −104.30 | NA | 50.0 | 32.00 | 55.73 |
| ment 3 | | | | | | | |
| Embodi- | 31.23 | −310.96 | −816.29 | NA | 50.0 | 32.00 | 5.89 |
| ment 4 | | | | | | | |
| Embodi- | 36.65 | 113.53 | −84.21 | NA | 50.0 | 32.00 | 22.15 |
| ment 5 | | | | | | | |
| Embodi- | 36.78 | 145.32 | −82.65 | 123.72 | 50.0 | 32.00 | 30.86 |
| ment 6 | | | | | | | |

TABLE 8

| | Embodiment 1 | Embodiment 2 | Embodiment 3 | Embodiment 4 | Embodiment 5 | Embodiment 6 |
|---|---|---|---|---|---|---|
| R2/f | −0.76 | −1.02 | −1.44 | −1.02 | −2.25 | −1.49 |
| TTL/ImgH | 0.78 | 0.55 | 1.06 | 0.98 | 1.09 | 1.15 |
| tan(HFOV) | 1.19 | 1.19 | 1.19 | 1.19 | 1.19 | 1.19 |

From the above description, it can be seen that the abovementioned embodiments of the disclosure have the following technical effects.

1) According to the eyepiece of the disclosure, before entering a human eye, light from the image source is reflected twice in the eyepiece, so that a physical distance between the human eye and the image source in a direction of the optical axis is reduced, and the eyepiece is light and thin. Moreover, in the eyepiece of the disclosure, the first lens has a positive refractive power or a negative refractive power, the second lens has a negative refractive power, the Abbe number Vd1 of the material of the first lens is greater than 5, and the Abbe number Vd2 of the material of the second lens is less than 30, so that the size of the lens is reduced to further achieve a light and thin structure of the eyepiece, and meanwhile, an imaging chromatic aberration is also reduced to further improve the imaging quality of the eyepiece.

2) According to the display device of the disclosure, which includes the eyepiece, so that the display device meets a requirement on a light and thin structure, and a displayed image is relatively high in quality.

The above is only the preferred embodiment of the disclosure and not intended to limit the disclosure. For those skilled in the art, the disclosure may have various modifications and variations. Any modifications, equivalent replacements, improvements and the like made within the spirit and principle of the disclosure shall fall within the scope of protection of the disclosure.

What is claimed is:

1. An eyepiece, comprising:
a lens component with a positive refractive power or a negative refractive power, the lens component comprising at least two lenses which are a first lens and a second lens respectively along a direction close to an image source;
a reflective linear polarizer, arranged on a surface, close to the image source, of the first lens or arranged on a surface of the second lens;
a reflective circular polarizer, arranged on a surface of the first lens, the reflective circular polarizer being arranged on a side, far away from the image source, of the reflective linear polarizer; and
a ¼λ wave plate, arranged between the reflective linear polarizer and the reflective circular polarizer,
wherein the first lens has a positive refractive power or a negative refractive power, the second lens has a negative refractive power, an Abbe number Vd1 of material of the first lens satisfies the following relationship: Vd1>5, and an Abbe number Vd2 of material of the second lens satisfies the following relationship: Vd2<30.

2. The eyepiece as claimed in claim 1, wherein a maximum lateral chromatic aberration of the eyepiece is LACL, LACL<60 μm.

3. The eyepiece as claimed in claim 1, wherein the surface, close to the image source, of the first lens is a second surface, and the second surface of the first lens is a convex surface.

4. The eyepiece as claimed in claim 3, wherein a radius of curvature of the second surface of the first lens is R2, and an effective focal length of the eyepiece is f, −3<R2/f<0.

5. The eyepiece as claimed in claim 1, wherein a distance on an optical axis between a center of an object-side surface of the first lens and a surface of the image source is a Total Track Length (TTL), and a half of a diagonal length of an effective pixel region of the surface of the image source is ImgH, TTL/ImgH<1.3.

6. The eyepiece as claimed in claim 1, wherein a maximum field of view of the eyepiece is a Horizontal Field Of View (HFOV), tan(HFOV)>1.

7. The eyepiece as claimed in claim 1, wherein the lens component further comprises a third lens, and the third lens is arranged on a side, far away from the first lens, of the second lens.

8. An eyepiece, comprising:
a lens component with a positive refractive power or a negative refractive power, the lens component comprising at least two lenses which are a first lens and a second lens respectively along a direction close to an image source;
a reflective linear polarizer, arranged on a surface, close to the image source, of the first lens or arranged on a surface of the second lens;
a reflective circular polarizer, arranged on any surface of the first lens, the reflective circular polarizer being arranged on the side, far away from the image source, of the reflective linear polarizer; and
a ¼λ wave plate, arranged between the reflective linear polarizer and the reflective circular polarizer.

9. The eyepiece as claimed in claim 8, wherein the first lens has a positive refractive power or a negative refractive power, and the second lens has a negative refractive power.

10. The eyepiece as claimed in claim 8, wherein an Abbe number Vd1 of material of the first lens satisfies the following relationship: Vd1>50, and an Abbe number Vd2 of material of the second lens satisfies the following relationship: Vd2<30.

11. The eyepiece as claimed in claim 8, wherein a maximum lateral chromatic aberration of the eyepiece is LACL, LACL<60 μm.

12. The eyepiece as claimed in claim 8, wherein the surface, close to the image source, of the first lens is a second surface, and the second surface of the first lens is a convex surface.

13. The eyepiece as claimed in claim 12, wherein a radius of curvature of the second surface of the first lens is R2, and an effective focal length of the eyepiece is f, −3<R2/f<0.

14. The eyepiece as claimed in claim 8, wherein a distance on an optical axis between a center of an object-side surface of the first lens and a surface of the image source is a Total Track Length (TTL), and a half of a diagonal length of an effective pixel region of the surface of the image source is ImgH, TTL/ImgH<1.3.

15. The eyepiece as claimed in claim 8, wherein a maximum field of view of the eyepiece is a Horizontal Field Of View (HFOV), tan(HFOV)>1.

16. The eyepiece as claimed in claim 8, wherein the lens component further comprises a third lens, and the third lens is arranged on a side, far away from the first lens, of the second lens.

17. A display device, comprising an eyepiece, wherein the eyepiece is the eyepiece as claimed in claim 1.

18. The display device as claimed in claim 17, wherein the display device is a head-mounted Virtual Reality (VR) display device.

19. A display device, comprising an eyepiece, wherein the eyepiece is the eyepiece as claimed in claim 8.

20. The display device as claimed in claim 19, wherein the display device is a head-mounted Virtual Reality (VR) display device.
